(19) United States
(12) Patent Application Publication
(10) Pub. No.: US 2026/0178892 A1
(43) Pub. Date: Jun. 25, 2026

(54) VISUAL TOKENIZATION ENABLING HIGH QUALITY VISUAL RECONSTRUCTION

(71) Applicant: NVIDIA Corporation, Santa Clara, CA (US)

(72) Inventors: Yue Zhao, Austin, TX (US); Fuzhao Xue, Singapore (SG); Scott Reed, Marietta, GA (US); Linxi Fan, San Jose, CA (US); Yuke Zhu, Austin, TX (US); Jan Kautz, Lexington, MA (US); Zhiding Yu, Cupertino, CA (US); De-An Huang, Cupertino, CA (US)

(21) Appl. No.: 19/427,271

(22) Filed: Dec. 19, 2025

Related U.S. Application Data
(60) Provisional application No. 63/738,405, filed on Dec. 23, 2024.

(51) Int. Cl. G06N 3/0495; G06N 3/0455

(52) U.S. Cl. CPC G06N 3/0495; G06N 3/0455

(57) ABSTRACT

The tokenization process of input text and visuals (e.g., images, videos, or frames of videos) can be separated into two stages. In a first stage, a large batch size can be used for text encoding and visual encoding while focusing on the first objective of an alignment loss and mean square loss objectives. In a second stage, the text encoder can be stopped, and the visual encoder can be prevented from making additional changes. The second stage focuses on a second loss objective of a weighted sum of the mean square loss, the perceptual loss, and the generative adversarial network loss objectives. In the second stage, a discrete set of tokens can be generated from the inputs, and the set of tokens can be further fine-tuned. A transformer, with an autoregressive model, can be applied to the set of discrete tokens.

### CROSS-REFERENCE

This application claims the benefit of U.S. Provisional Application Ser. No. 63/738,405, filed by Yue Zhao, et al., on Dec. 23, 2024, entitled “SYSTEM AND METHOD FOR QUANTIZED LANGUAGE-IMAGE PRETRAINING” commonly assigned with this application and incorporated herein by reference in its entirety.

### TECHNICAL FIELD

This application is directed, in general, to language models and, more specifically, to multimodal language modeling.

### BACKGROUND

Language models (LMs) are a type of machine learning (ML) model that are trained on text data to generate words based on the context of given text. LMs are used for various functions, such as auto-suggestions when typing, content generation, document summarization, and conversational artificial intelligence (AI). Large language models (LLMs) are a type of language model that have been trained on massive amounts of text data and use deep learning to identify complex data patterns. As suggested by the name, small language models (SLMs) are smaller in scale than LLMs and are often trained on specific datasets.

Multimodal language models (MLMs) are ML models that are capable of processing different types of data to generate outputs. For example, MLMs can generate outputs by processing different modalities of data, such as images, audio, and text. As such, MLMs can be trained using different modes of data. Visual tokenization is one process that is used in training and inferencing when the data mode is a still image or images from a video, collectively referred to as visuals. Analogous to LLM tokenizers that losslessly transform a text string into discrete tokens, visual tokenization, such as in visual language models (VLMs), aim to map an image or video to discrete tokens that can be processed by MLMs while keeping as much visual information as possible. The tokens can be visual elements that represent images, such as objects, textures, colors, or other parameters.

### SUMMARY

In one aspect, a quantized language-image pretraining (Q-LIP) system to train a Q-LIP model using two stages is disclosed. In one embodiment, the Q-LIP system includes (1) a text encoder configured to generate encoded text from input text corresponding to a set of training visuals that are sourced from one or more of images or frames of videos, (2) a visual encoder configured to generate encoded images from the set of training visuals, (3) a quantizer configured to fine-tune the encoded images using the encoded text to generate quantized encoded images, and (4) a visual decoder configured to construct new visuals from the quantized encoded images, wherein in a first stage the visual encoder generates the encoded images and the text encoder generates the encoded text, and the first stage utilizes a first stage batch size, and in a second stage the text encoder is not used, the visual encoder does not make further changes to the encoded images, the quantizer fine-tunes the encoded images, the visual decoder fine-tunes the encoded images after the quantizer, and a second stage batch sized is used with the quantizer that is smaller than the first stage batch size.

In a second aspect, a system is disclosed. In one embodiment, the system includes (1) a receiver, configured to receive input parameters, input text, and a set of training visuals, wherein the input text corresponds to the set of training visuals, and (2) one or more processors configured to generate encoded text from the input text, generate encoded images from the set of training visuals, quantize the encoded text and the encoded images to generate a set of discrete tokens, fine-tune the set of discrete tokens, wherein the encoded text and the encoded images are generated in a first stage using a first batch size and a first loss objective, and the set of discrete tokens are generated in a second stage using a second batch size and a second loss objective, where the first batch size is larger than the second batch size.

In a third aspect, a method is disclosed. In one embodiment, the method includes (1) receiving input parameters, input text, and a set of training visuals, wherein the input text corresponds to the set of training visuals, (2) encoding the input text to generate encoded text, (3) encoding the set of training visuals to generate encoded images, (4) generating a set of discrete tokens using a quantizer, the encoded text, and the encoded images, and (5) fine-tuning the set of discrete tokens, wherein the encoded text and the encoded images are generated in a first stage using a first batch size and a first loss objective, and the set of discrete tokens are generated in a second stage using a second batch size and a second loss objective, where the first batch size is larger than the second batch size.

In a fourth aspect, a non-transitory computer program product having a series of operating instructions stored on a non-transitory computer-readable medium that directs a data processing apparatus, when executed thereby to perform operations is disclosed. In one embodiment, the operations include (1) receiving input parameters, input text, and a set of training visuals, wherein the input text corresponds to the set of training visuals, (2) encoding the input text to generate encoded text, (3) encoding the set of training visuals to generate encoded images, (4) generating a set of discrete tokens using a quantizer, the encoded text, and the encoded images, (5) fine-tuning the set of discrete tokens, wherein the encoded text and the encoded images are generated in a first stage using a first batch size and a first loss objective, and the set of discrete tokens is generated in a second stage using a second batch size and a second loss objective, where the first batch size is larger than the second batch size, and (6) applying an autoregressive model to generate new visuals using the set of discrete tokens.

### BRIEF DESCRIPTION

Reference is now made to the following descriptions taken in conjunction with the accompanying drawings, in which:

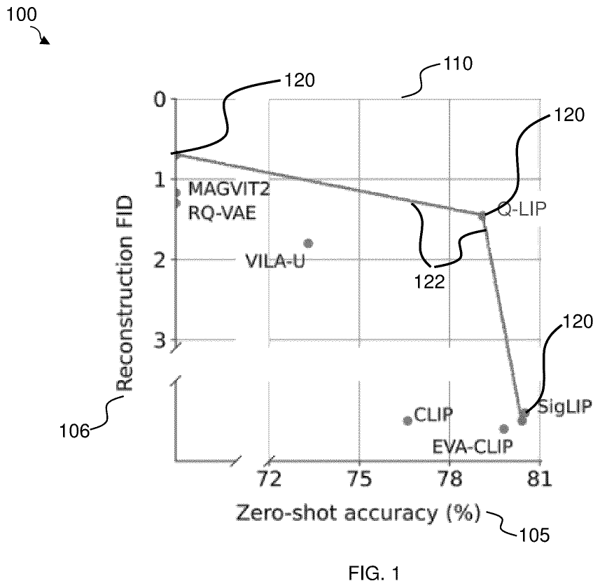

FIG. 1 is an illustration of a diagram of an example chart showing a relationship between zero-shot accuracy and FID;

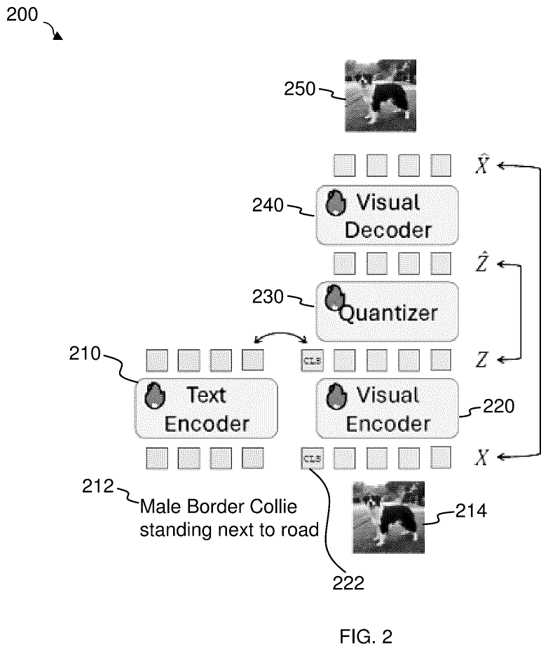

FIG. 2 is an illustration of a diagram of an example overview of a two-stage flow of Q-LIP;

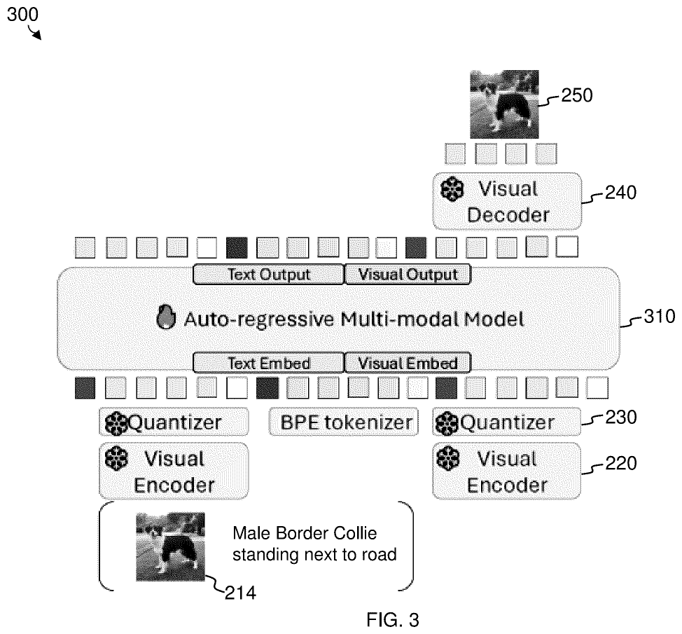

FIG. 3 is an illustration of a diagram of an example transformer flow that extends the functional flows of two-stage flow of FIG. 2;

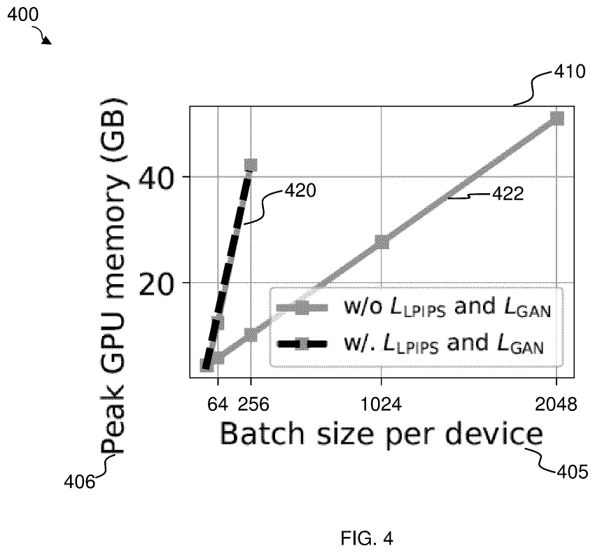

FIG. 4 is an illustration of a diagram of an example chart 400 of memory usage of Q-LIP;

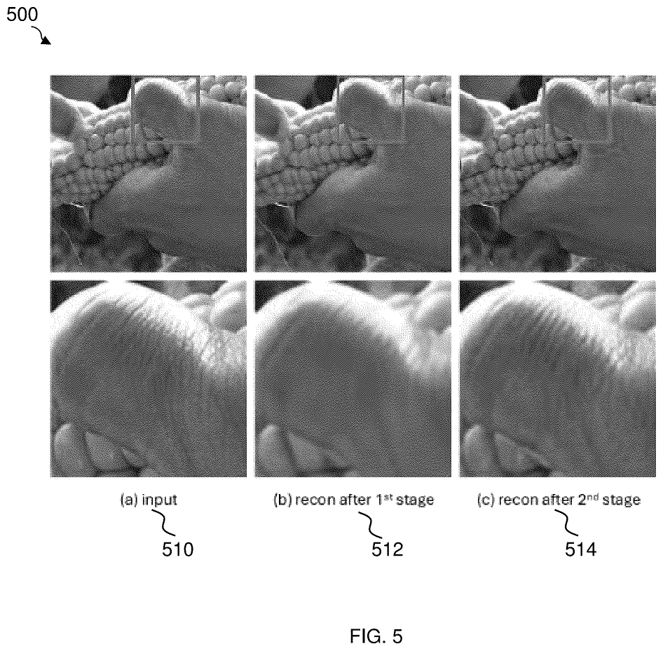

FIG. 5 is an illustration of a diagram of an example comparison using the Q-LIP processes;

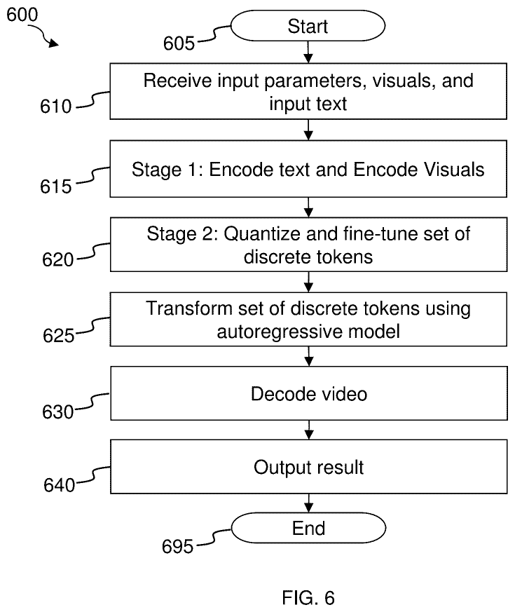

FIG. 6 is an illustration of a flow diagram of an example method to implement a Q-LIP model;

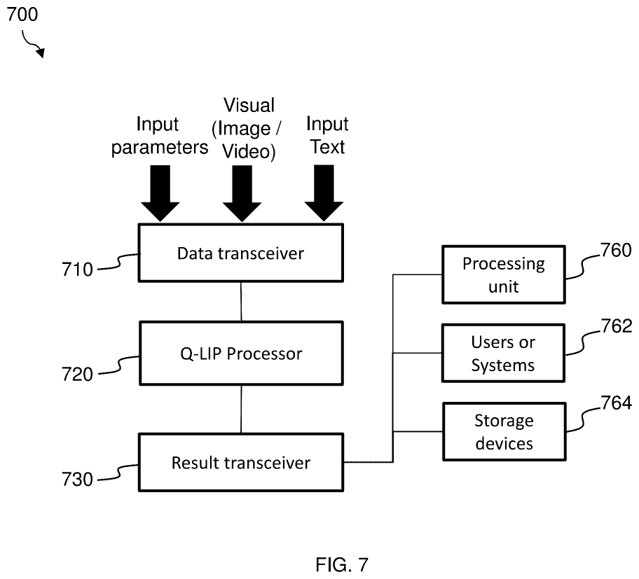

FIG. 7 is an illustration of a block diagram of an example Q-LIP system; and

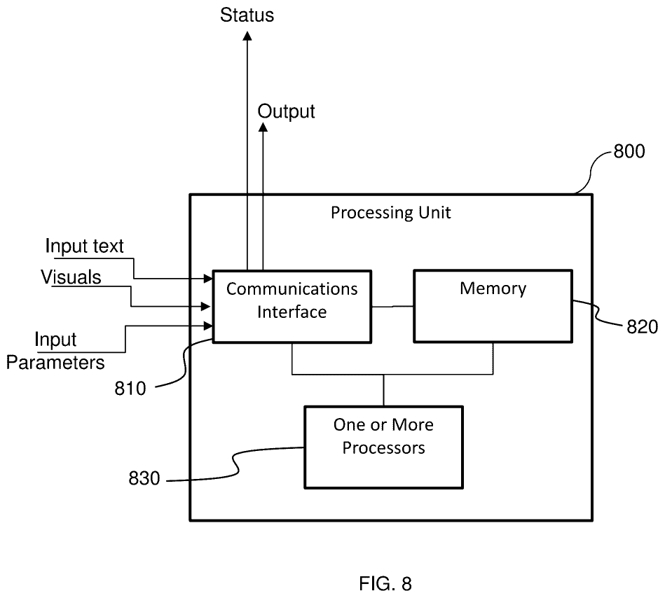

FIG. 8 is an illustration of a block diagram of an example of a Q-LIP controller according to the principles of the disclosure.

### DETAILED DESCRIPTION

For some uses of artificial intelligence (AI), a text prompt can be provided to an AI model, and an image or video can be generated from that prompt. To process the text prompt, a text tokenization process can be used to identify key components of the text prompt, allowing the AI model to construct the image or video using the encoded key components. In addition to the text prompt, the AI model can be trained on images and video, e.g., visuals. These visuals can be tokenized and encoded, thereby put into a condition where they can be used by the AI model in future image or video generation. Previous approaches to these steps focus on visual reconstruction objectives for the visual tokenization and leave the visual-language multimodal modeling solely to the downstream auto-regressive model. This can lead to tokenization that compresses the inputs visually and not semantically. This tokenization can lead to the two modalities competing. Therefore, this results in a slowing down of the training of the downstream auto-regressive model.

Auto-regressive sequence modeling and its variants have become the state-of-the-art paradigm for natural language modeling, multimodal understanding, and visual generation. Despite progress, a unified auto-regressive model that performs well from various modalities can be difficult to train. One issue lies in visual tokenization. An auto-encoder can learn to reconstruct the input visuals with a set of visual tokens while leaving the joint visual-language modeling to the auto-regressive model. This can lead to tokenization that compresses the inputs visually, but not semantically, which can lead to the two modalities competing.

This disclosure presents processes to perform multimodal alignment in the visual tokenization phase. The result can be a generic visual tokenizer for multimodal language modeling that improves capturing semantics and can reconstruct visuals. A binary spherical quantization (BSQ)-based auto-encoder can be trained with a text-aligned visual-encoder through a contrastive objective. The disclosed processes can be labeled as a quantized language-image pretraining (Q-LIP) framework.

Q-LIP can address at least two challenges during training. First, contrastive alignment and regression objectives can compete and can be hard to balance. Second, contrastive learning can rely on large-batch training, while reconstruction losses can incur a heavy memory cost and thus tend to favor small batch training. To address the first challenge, it can be observed that the difference in the gradient magnitude can lead to different convergence rates between the contrastive visual-text alignment and pixel reconstruction objectives. Q-LIP can utilize an automated weighting scheme between the contrastive visual-text alignment and pixel reconstruction objective losses. The loss terms can be weighed by the respective inverse of their post-hoc loss values without extra cost to compute the gradient.

To address the second challenge, a two-stage training recipe can be implemented. In the first stage, Q-LIP can be trained with a combination of an alignment loss objective and a mean squared error (MSE) (e.g., L2) loss objective with a transformer architecture. In some aspects, the transformer architecture can be memory-efficient. In the second stage, the text encoder is not used, the visual encoder does not make further changes to the encoded images, and the contrastive loss can stop further optimization. These changes in the second stage can allow for a smaller batch size and can enable fine-tuning (e.g., applying a fine-tuning objective) of the bottleneck quantizer and the decoder using a weighted sum of MSE, a perceptual loss objective (as defined and used in the industry), and a generative adversarial network (GAN) loss objective (as defined and used in the industry), such as a performance degradation caused by quantization, leading to quality loss. A smaller batch size is dependent on the processor and model size. The batch size can go down to one per processor. In practice, the batch size is typically in a range of 64-256 per processor, while smaller and larger range values can be used in some aspects.

Through testing, Q-LIP has shown competitive reconstruction results compared to other conventional solutions, including continuous tokenizers and discrete tokenizers under a similar compression ratio. At the same time, Q-LIP can yield visual-text alignment capability similar to a contrastive language-image pre-training (CLIP) objective. The effectiveness of the Q-LIP tokenizer can be validated using a wide spectrum of multimodal understanding and generation benchmarks. Prior industry understanding is that vision tokenizers can lead to degradation when used in VLMs. On text-conditioned image generation, Q-LIP can improve the generation of Fréchet inception distance (FID) and better text-visual alignment (as shown in Table 12 of the Additional Material in the provisional), qualitatively compared to language-agnostic visual tokenizers. Q-LIP can enable a unified mixed modal auto-regressive model that can handle language-only, image-to-text, and text-to-image tasks in the same model.

In more detail, visual tokenization can transform a visual (e.g., an image or a frame from a video) to a set of discrete tokens, which can be used for compression, generation, or multimodal understanding via an auto-regressive sequence modeling process. Visual tokenization can have three components: a visual encoder [symbol] , a quantization bottleneck [symbol] , and a visual decoder [symbol] . Given an input visual X∈ [symbol] , the visual encoder [symbol] can produce a grid of d-dimensional latent [symbol] embeddings

$$Z = ℰ ( X ) ∈ {ℝ}^{( \frac{H}{p} \times \frac{W}{p} ) \times d}$$

downsampled by a factor p. The quantization bottleneck [symbol] can transform the real-valued latent embeddings into discrete tokens {c₁, . . . , c_{K}} in an element-wise fashion:

$$\hat{Z} = Q ( Z ) ∈ {\{ {c}_{1} , … , {c}_{K} \}}^{( \frac{H}{p} \times \frac{W}{p} )} .$$

The decoder [symbol] can map the discretized tokens back to the raw pixel space \hat{X}= [symbol] (\hat{Z})∈ [symbol] . The entire network ( [symbol] , [symbol] , and [symbol] ) can be trained by minimizing a weighted sum of MSE loss [symbol] =∥\hat{X}−X∥₂, quantization loss [symbol] ( [symbol] ), and regularization terms, e.g., a commitment loss, or perceptual and adversarial losses as shown in Equations 1.

$$Example commitment loss , example perceptual loss , and examples adversarial loss \\ {ℒ}_{commitment} = \vert stop\_grad ( \hat{z} ) - z \vert {ℒ}_{perceptual} = {\sum }_{l} \frac{1}{{H}_{l} \cdot {W}_{l}} {\sum }_{h , w} \vert {w}_{l} ⊙ ( {VGG}^{l} ( X ) - {VGG}^{l} ( \hat{X} ) ) \vert {ℒ}_{GAN} = {𝔼}_{X} [ log D ( X ) ] + {𝔼}_{\hat{X}} [ log ( 1 - D ( \hat{X} ) ) ] \qquad Equations 1$$

Vector quantization (VQ) can map latent inputs z∈Z to the closest entry in a learnable codebook C=[c₁, . . . , c_{K}]∈ [symbol] : [symbol] =argmin_{c}_{ₖ}_{∈c}∥z−cₖ∥₂. VQ can use the straight-through estimator (STE) to propagate gradients through the quantization bottleneck. Empirically, VQ can scale poorly with increasing vocabulary size K.

Binary spherical quantization (BSQ) and look-up free quantization (LFQ) can provide an improved scalable alternative VQ. BSQ and LFQ can optimize an implicit codebook. For example, BSQ can project a hypercube onto a unit sphere and use the corners of the hypercube as code vectors

$${C}_{B S Q} = {\{ - \frac{1}{\sqrt{L}} , \frac{1}{\sqrt{L}} \}}^{L} .$$

Each corner cₖ∈C_{BSQ} can correspond to a unique token k. BSQ can linear-project the d-dimensional latent embedding z to an L-dimensional unit hypersphere u∈S^{L-1}, apply a binary quantization per axis

$$\hat{u} = \frac{1}{\sqrt{L}} sign ( u ) ,$$

and can back-project to a quantized vector in the original latent space \hat{z}. The code index at inference can be obtained through binarization

$$k = {\sum }_{i = 1}^{L} {1}_{[ {u}_{i} > 0 ]} {2}^{i - 1} .$$

To optimize for an effective latent code and encourage usage of the implicit codebook, the quantization loss can use an entropy objective as shown in Equation 2.

$$Equation 2$$

$$Example entropy objective$$

$${ℒ}_{B S Q} = 𝔼 [ H ( 𝒬 ( z ) ) ] - γ H ( 𝔼 [ 𝒬 ( z ) ] )$$

where the entropy terms rely on a soft quantization, and an efficient approximate computation exists.

The quantization-based auto-encoder can enable the compression of complex visual content and can generate photorealistic images. The learned visual tokens can yield inferior performance on understanding tasks because of a lack of semantic training objectives.

Q-LIP can learn visual representation from natural language supervision via a contrastive objective. The training data can be a visual-text pair (X,Y), where Y can be a free-form alt-text or short caption encoded in enumerable text tokens. Q-LIP can employ a visual encoder [symbol] and a text encoder [symbol] to obtain the visual and text embeddings

$$v = \frac{{ε}_{v} ( X )}{{‖ {ε}_{v} ( x ) ‖}_{2}} , and w = \frac{{ε}_{v} ( Y )}{{‖ {ε}_{v} ( Y ) ‖}_{2}} .$$

Given a batch of samples B, the contrastive loss can learn to associate embedding pairs for the same sample and separate pairs that are not, such as shown in Equation 3.

$$Equation 3$$

$$Example contrastive loss learnings$$

$${ℒ}_{a l i g n} ( v , w ) = {\sum }_{i = 1}^{\vert B \vert} ( log \frac{{e}^{{tv}_{i}^{τ} {w}_{i}}}{{\sum }_{i = 1}^{\vert B \vert} {e}^{{tv}_{i}^{τ} {w}_{j}}} + log \frac{{e}^{{tv}_{i}^{τ} {w}_{i}}}{{\sum }_{j = 1}^{\vert B \vert} {e}^{{tv}_{i}^{τ} {w}_{i}}} )$$

The contrastive-based alignment can lead to improved visual representations, which can be integrated into LLMs for visual-language understanding. Contrastive-based alignment cannot generate visual content due to the encoder-only design.

Q-LIP can implement a text-aligned visual tokenizer whose visual embeddings can be projected in a shared space with the text embeddings. The BSQ-autoencoder can be used with a contrastive language-image alignment branch. Specifically, Q-LIP can use a text encoder [symbol] to obtain the language feature w of alt-text Y accompanying the input visual X. In the visual encoder [symbol] , Q-LIP can append a learnable classification token x_{cis} and obtain an extra latent embedding z_{cis} through εᵥ,

$$( Z , {z}_{c l s} ) = E ( X ; {x}_{c l s} ) ∈ {ℝ}^{( \frac{H}{p} \times \frac{W}{p} + 1 ) \times d} .$$

The normalized global visual feature for alignment can be computed through a linear projection head

$${h}_{v} : v = \frac{{h}_{v} ( {z}_{c l s} )}{{‖ {h}_{v} ( {z}_{c l s} ) ‖}_{2}} .$$

Conventionally, a perceptual and adversarial loss can be used for high-quality reconstruction. Perceptual and adversarial losses can rely on an extra convolutional network and thus increase the memory footprint. Effective contrastive learning can utilize a large batch size (32 k˜98 k). To reduce memory costs, Q-LIP can decouple training into two stages. In the first stage, Q-LIP can optimize a weighted sum of reconstruction loss and quantization loss, as shown in Equation 2, and contrastive loss, as shown in Equation 3, without the perceptual and adversarial loss, as shown in Equation 4.

$$Equation 4$$

$$Example optimization loss objective$$

$${𝔼}_{X , Y} [ {α}_{r} {ℒ}_{m s e} + {α}_{q} {ℒ}_{B S Q} + {α}_{a} {ℒ}_{a l i g n} ( v , w ) ]$$

where αᵣ, α_{q}, and αₐ are weighting terms for the respective loss calculations.

Equation 4 can enable Q-LIP to prioritize learning semantics-rich representations over better visual reconstruction, which may not be beneficial for representation learning. In the second stage, Q-LIP can improve the reconstruction quality and restore higher-frequency details by applying a fine-tuning objective to the quantization bottleneck and the visual decoder, as shown in Equation 5. Q-LIP processes can specify that the text encoder is not used and the visual encoder does not make further changes to the encoded images to prevent degradation when the batch-size restriction is relaxed.

$$Equation 5$$

$$Example of fine - tuning the quantization bottleneck and visual decoder$$

$${𝔼}_{X} [ {α}_{r}^{′} {ℒ}_{m s e} + {α}_{q}^{′} {ℒ}_{B S Q} + {α}_{p}^{′} {ℒ}_{LPIPS} + {α}_{g}^{′} {ℒ}_{G A N} ]$$

where αᵣ′=α_{q}′=a weighting value, for example, 1.0,
   αₚ′=α_{g}′=a weighting value, for example, 0.1, and
   LPIPS is a learned perceptual image patch similarity to judge the quality of visuals.

Training a visual tokenizer with a reconstruction objective can be data efficient. In contrast, CLIP-style training can utilize 30-50 billion samples to maximize performance. To narrow the gap, Q-LIP can initialize the visual encoder from either masked image modeling (MIM) pre-training or CLIP and the text encoder from CLIP. Empirically, this can significantly increase convergence, and training can be satisfactorily completed using fewer samples (for example, 4 billion samples). In some aspects, Q-LIP can achieve satisfactory training 10× faster than training from scratch.

Q-LIP can balance the reconstruction and alignment objectives, namely αᵣ:αₐ. Looking at the gradient of each loss with respect to the last shared layer, i.e., the linear layer in the visual encoder's last multi-layer perceptron (MLP), there can be a difference of several orders of magnitude, leading to different convergence rates between the alignment and reconstruction objectives. The problem can be more distinct when the straight-through estimator exists. This problem can be visualized by comparing the gradient norm of two AEs, one of whose quantization bottleneck is replaced with an identity mapping without compression. To mitigate this problem, Q-LIP can use a post-hoc way to weigh the two terms. Specifically, we first train the model with either reconstruction or alignment loss and then choose the multi-task loss weight to be inversely proportional to the final loss values, i.e., αᵣ/αₐ≈ [symbol] (∞)/ [symbol] (∞), where [symbol] (□) denotes the loss value after convergence. For example, wherein a reconstruction objective and an alignment objective are balanced by first training the Q-LIP model with a first loss weight of one of a reconstruction loss or an alignment loss, and then training the Q-LIP model using a second loss weight that is inversely proportional to the first loss weight.

In some aspects, adaptive weight methods are not utilized. Adaptive weight tuning utilizes computing the gradient with respect to the last shared layer in the visual encoder. Therefore, an additional backward call of the decoder is used, which can introduce non-negligible

$$( \sim \frac{1}{3} )$$

time and memory overhead.

In addition to the training recipe, Q-LIP can improve the tokenizer by replacing linear projection from the latent space z∈ [symbol] to the codebook space u∈S^{L-1} with an MLP. The mapping from û to \hat{z} can be symmetrical, as shown in Equation 6.

$$Equation 6$$

$$Example replacement of linear projection with MLP$$

$$u = {MLP}_{⇓} ( z ) , \hat{u} = \frac{1}{\sqrt{L}} sign ( u ) , \hat{z} = {MLP}_{⇑} ( \hat{u} )$$

where MLPN [symbol] denotes a down or up projection, respectively.

In some aspects, since the quantization bottleneck is deeper, Q-LIP can add an auxiliary term ∥sg(\hat{Z})−Z∥₂ during training, similar to the commitment loss in other solutions. Though the linear case does not require the auxiliary term, adding it can improve reconstruction in Q-LIP.

Once the visual tokens are aligned with the language, Q-LIP can concatenate the visual tokens with language tokens, inserting appropriately padded special tokens. The padded special tokens can tell the autoregressive transformer to predict if the next token should be a visual token or a text token. For example, if the task is image captioning (given image, output text), then after feeding the visual tokens, one more special token can be added so that the autoregressive transformer knows to predict a text token. In some aspects, a transformer can be configured to transform the encoded images to a set of discrete tokens and to insert special tokens as padding within the set of discrete tokens. On top of the visual-textual token sequence, a transformer can be applied to predict the next token in an auto-autoregressive manner while minimizing the concern of whether the next token would generate multiple modalities.

For the visual-textual token sequence steps, Q-LIP can begin with an established architecture, for example, the Llama 3 architecture. To handle the issue of norm growth due to competition from multiple modalities, a query-key normalization (QK-Norm) can be applied in the attention layer. For example, a QK-Norm can be applied in a first attention layer of the input text and a second attention layer of the set of training visuals.

Adding QK-Norm can be compatible with a pre-trained architecture, such as Llama 3, without QK-Norm. Therefore, rather than training from scratch, Q-LIP can start from the established architecture initialization, which can accelerate training. Q-LIP can augment the token embedding and the output layers to fit the visual tokens. The augmented part can be initialized with the mean of the existing text embeddings

$${e}_{i} = \frac{( {\sum }_{j = 1}^{{V}_{t}} {e}_{j} )}{{V}_{t}} ,$$

∀i∈[Vₜ+1,Vₜ+Vᵥ] where Vₜ and Vᵥ denotes the vocabulary size of textual and visual tokens, respectively.

To alleviate the logit shift problem, Q-LIP can apply the softmax function to the textual and visual tokens separately, as shown in Equation 7, which demonstrates a logit shift correction algorithm.

$$Equation 7$$

$$Example algorithm for correcting a logit shift$$

$${\sum }_{i = 1}^{{V}_{t} + {V}_{v}} ( {1}_{[ i \leq {V}_{t} ]} log \frac{{e}^{{x}_{i}}}{{\sum }_{j = 1}^{{V}_{t}} {e}^{{x}_{j}}} + {1}_{[ i > {V}_{t} ]} log \frac{{e}^{{x}_{i}}}{{\sum }_{j = {V}_{t} + 1}^{{V}_{t} + {V}_{v}} {e}^{{x}_{j}}} )$$

Each mini-batch can be a mixture of text, image-text, text-image, or other combinations. Q-LIP can utilize a calm-down schedule for mixing data, i.e., the proportion of text data in a mini-batch linearly decays from r₀ to r_{T} with respect to training step t, as shown in Equation 8. For example, the quantizer can utilize a calm-down schedule for a proportion of text data decaying with respect to subsequent training steps.

$$Equation 8$$

$$Example calm - down schedule$$

$$r ( t ) = \{ \begin{matrix}\frac{{r}_{T} - {r}_{0}}{T} ( t - T ) , & if t \leq T \\ {r}_{T} , & otherwise\end{matrix}$$

where r₀, r_{T} are pre-defined hyper-parameters and 0<r_{T}<r₀. This can prevent the language modeling ability from collapsing at the beginning of multimodality training.

Turning now to the figures, FIG. 1 is an illustration of a diagram of an example chart 100 showing a relationship between zero-shot accuracy and FID. Conventional visual tokenizers can typically excel at either understanding, e.g., high zero-shot accuracy, or reconstruction, e.g., low reconstruction FID. Q-LIP can perform well on understanding and reconstruction with a marginal performance drop, allowing an improved unified multi-modal understanding and generation.

Chart 100 has an x-axis 105 showing the zero-shot accuracy percentage and a y-axis 106 showing the FID value (where lower is better). A plot area 110 shows how conventional solutions and the disclosed processes perform against the two measures. Points 120 are approximately where Q-LIP performs against the zero-shot accuracy measure and the reconstruction FID measure, as these factors are balanced in different proportions. Lines 122 approximate the performance of Q-LIP across the axis' values.

FIG. 2 is an illustration of a diagram of an example overview of a two-stage flow 200 of Q-LIP. In a first stage of two-stage flow 200, Q-LIP can be trained with a combination of alignment loss and MSE loss. In some aspects, this training can start with a BSQ autoencoder while adding a contrastive language-image alignment branch.

A text encoder 210 can be used to obtain the language features of an input text 212 accompanying an input visual 214 (e.g., generating encoded text). In a visual encoder 220, a learnable classification token can be appended to obtain an extra latent embedding 222. An optimized weighted sum of reconstruction loss can be calculated using the quantization loss (such as Equation 2), and contrastive loss (such as Equation 3) without the perceptual and adversarial loss, as shown in Equation 4, where learning semantics-rich representation is prioritized over better visual reconstruction.

In a second stage of two-stage flow 200, text encoder 210 is not used in the processing, visual encoder 220 does not make further changes to the encoded images, and the contrastive loss is no longer optimized. In the second stage, a bottleneck quantizer 230 and a visual decoder 240 can be fine-tuned using a fine-tuning objective, thereby generating quantized encoded images. The fine-tuning can improve the reconstruction quality and restore higher-frequency details, as shown by Equation 5. The result can be a reconstructed visual 250.

FIG. 3 is an illustration of a diagram of an example transformer flow 300 that extends the functional flows of two-stage flow 200 of FIG. 2. With the text-aligned visual tokenizer as output from bottleneck quantizer 230, a transformer 310 can transform the visual into visual tokens and concatenate them with text tokens. Transformer 310 can then use an autoregressive multimodal model to model jointly, for example, by using an autoregressive modeler. Two-stage flow 200 and transformer flow 300 can form a unified multimodal model (UM³). The initialization of the augmented part of the token embedding to fit the visual tokens can be done using the vocabulary size of the textual and visual tokens. The logit shift can be alleviated, such as by using Equation 7.

FIG. 4 is an illustration of a diagram of an example chart 400 of memory usage of Q-LIP. Training Q-LIP in one stage may not be feasible. When using a perceptual loss and an adversarial loss for reconstruction, the memory footprint can increase since these losses rely on an extra convolutional network. Effective contrastive learning leans towards having larger batch sizes. Therefore, to reduce memory costs, Q-LIP training is decoupled into two stages, as described in FIGS. 2 and 3.

Chart 400 has an x-axis 405 showing the batch size per device and a y-axis 406 showing the peak GPU memory in gigabytes (GB). A plot area 410 shows an example difference between fine-tuning with or without LPIPS and GAN loss adjustments, such as shown in Equation 5. Line 420 shows the memory usage increases rapidly as the batch size increases when employing the LPIPS and GAN adjustments. Line 422 shows the memory usage increasing more slowly than line 420 when not employing the LPIPS and GAN adjustments. By separating the disclosed Q-LIP process into two stages, the memory constraints can be reduced.

FIG. 5 is an illustration of a diagram of an example comparison 500 using the Q-LIP processes. Comparison 500 shows the reconstruction results using an input visual 510. Reconstructed visual 512 shows an example output after the completion of the first stage of Q-LIP. Reconstructed visual 514 shows an example output after the completion of the second stage of Q-LIP. Reconstructed visual 514 shows more high-frequency details in the output visual.

FIG. 6 is an illustration of a flow diagram of an example method 600 to implement a Q-LIP model. Method 600 can be performed on a computing system, for example, Q-LIP system 700 of FIG. 7 or Q-LIP controller 800 of FIG. 8. The computing system can be one or more processors in various combinations (e.g., CPUs, GPUs, SIM Ds, or other types of processors), a data center, a cloud environment, a server, a laptop, a mobile device, a smartphone, a PDA, or other computing system capable of receiving the thread requests, and capable of executing threads in parallel. Method 600 can be encapsulated in software code or hardware, for example, an application, code library, code module, dynamic link library, module, function, RAM, ROM module, and other software and hardware implementations. The software can be stored in a file, database, or other computing system storage mechanism. Method 600 can be partially implemented in software and partially in hardware. Method 600 can perform the steps for the described processes, for example, performing a two-stage visual decoding process and a transformation process with an auto-regressive model.

Method 600 starts at a step 605 and proceeds to a step 610. In step 610 input parameters, a visual (i.e., an image, a video or frames from a video) (e.g., a set of training visuals sourced from one or more images or frames of videos), and an input text can be received. The visual and the input text correspond to each other, forming a visual-text pair. The input parameters can include weighting values to use, such as specified in Equations 3 and 4. The input parameters can include the hyperparameters to use, such as in Equation 8. The input parameter can include a first stage batch size and a second stage batch size, where the second stage batch size is smaller than the first stage batch size.

In a step 615, a first stage can be implemented. The first stage can perform the actions of the text encoder and visual encoder (e.g., image encoder or frame encoder). The training process can learn the association of the visual-text pair using a contrastive loss objective, for example, shown in Equation 3, and a perceptual and adversarial loss objective, for example, shown in Equation 4. The first stage utilizes a smaller batch size than the second stage to improve the efficiency of the encoding process.

In a step 620, a second stage can be implemented. In the second stage, the text encoder can be removed from the processing, and the visual encoder does not make further changes to the encoded images. A quantization process can be conducted to generate a set of discrete tokens, which can then be fine-tuned, for example, as shown in Equation 5. The second stage can utilize a larger batch size than the first stage.

In a step 625, a transformation model can be applied to the set of discrete tokens. The transformation model can apply an autoregressive multimodal model to estimate (e.g., predict the next token) for new objects or new positionings of objects as initially prescribed by the input data, such as using an autoregressive modeler. In an optional step 630, the output of the autoregressive model can be used by a visual decoder to generate new visuals. In an optional step 640, the trained Q-LIP model can be saved or stored for later use, or the model can be used to generate new visuals using a text prompt. Method 600 ends at a step 695.

FIG. 7 is an illustration of a block diagram of an example Q-LIP system 700. Q-LIP system 700 can be implemented in one or more computing systems or one or more processors. In some aspects, Q-LIP system 700 can be implemented using a Q-LIP controller, such as Q-LIP controller 800 of FIG. 8. Q-LIP system 700 can implement one or more aspects of this disclosure, such as method 600 of FIG. 6.

Q-LIP system 700, or a portion thereof, can be implemented as an application, a code library, a dynamic link library, a function, a module, a header file, other software implementations, or combinations thereof. In some aspects, Q-LIP system 700 can be implemented in hardware, such as a ROM, a graphics processing unit, or other hardware implementation. In some aspects, Q-LIP system 700 can be implemented partially as a software application and partially as a hardware implementation. Q-LIP system 700 is a functional view of the disclosed processes, and an implementation can combine or separate the functions in one or more software or hardware systems.

Q-LIP system 700 includes a data transceiver 710, a Q-LIP processor 720, and a result transceiver 730. The output, e.g., the response to the query, can be communicated to a data receiver, such as one or more of processing systems 760 (one or more combinations of processors, or processing cores), one or more users or systems 762, or one or more storage devices 764. The output can be used to present a response to a user, stored for future use, or used as an input into other processing systems or machine learning systems.

In some aspects, the results of Q-LIP processor 720, such as those communicated to one or more of processing systems 760, one or more storage devices 764, or one or more users or systems 762, can be used as input into another process or system, such as a machine learning system. The results can be used for further processing, such as for input into artificial intelligence learning, for validation of other system processes, or real-world applications, such as constructing new visuals (e.g., images, videos, or frames of videos), building a library of Q-LIP training that can be used in future processing.

Data transceiver 710 can receive the input parameters, input text, and visuals (e.g., image, video, or frames from a video) (e.g., a set of training visuals). The input parameters can be algorithms to use, such as the MSE algorithm or another algorithm, various weighting parameters (e.g., LPIPS, GAN, or other weighting parameters), batch sizes, and other operational parameters. The input text can describe the visuals. The visuals can be one or more images, videos, or frames of video, e.g., an image, a video, a series of images, one or more frames from a video, or various combinations thereof. In some aspects, data transceiver 710 can be part of Q-LIP processor 720.

Result transceiver 730 (e.g., a transmitter) can communicate one or more outputs (e.g., results), to one or more data receivers, such as one or more of processing systems 760, one or more users or systems 762, storage devices 764, or other related systems, whether proximate result transceiver 730 or distant from result transceiver 730. Data transceiver 710, Q-LIP processor 720, and result transceiver 730 can be, or can include, conventional interfaces configured for transmitting and receiving data. Data transceiver 710, Q-LIP processor 720, or result transceiver 730 can be implemented as software components, for example, a virtual processor environment, as hardware, for example, circuits of an integrated circuit, or combinations of software and hardware components and functionality. The functionality described for these components remains intact regardless of how the functionality is implemented.

Q-LIP processor 720 (e.g., one or more processors such as processor 830 of FIG. 8) can implement the analysis and algorithms as described herein, utilizing the input parameters. Q-LIP processor 720 can execute code to implement a two-stage decoding model and a transformer model, execute code to process a visual, apply an autoregressive model, or various combinations thereof. In some aspects, Q-LIP processor 720 can perform the functions of an autoregressive modeler, which can apply the autoregressive model as described herein. Q-LIP processor 720 can be one or more of a multicore processor, a multiprocessor system, or a streaming multiprocessor. Q-LIP processor 720 can be implemented by a central processor unit (CPU), a graphics processor unit (GPU), or other types of processors. Q-LIP processor 720 can be a non-transitory computer program product having a series of operating instructions stored on a non-transitory computer-readable medium that directs a video processing apparatus, when executed thereby to perform operations as disclosed herein.

A memory or data storage system of Q-LIP processor 720 (such as a core cache, L1 cache, L2 cache, or other memory systems) can be configured to store the processes and algorithms for directing the operation of Q-LIP processor 720. Q-LIP processor 720 can include a processor that can be configured to operate according to the analysis operations and algorithms disclosed herein, and an interface to communicate (transmit and receive) data.

FIG. 8 is an illustration of a block diagram of an example of a Q-LIP controller 800 according to the principles of the disclosure. Q-LIP controller 800 can be stored on one computer or multiple computers. The various components of Q-LIP controller 800 can communicate via wireless or wired conventional connections. A portion or a whole of Q-LIP controller 800 can be located at one or more locations. In some aspects, Q-LIP controller 800 can be part of another system (e.g., processor, core, server, or other systems), and can be integrated with one device, such as a part of a processing system. Q-LIP controller 800 represents a demonstration of the functionality employed for the disclosure, and implementations can use a variety of devices, for example, circuits of a processor, dedicated processors, virtual systems, servers, other computing or processing systems, be in software or hardware, or various combinations thereof.

Q-LIP controller 800 can be configured to perform the various functions disclosed herein including receiving input parameters, input text, and visuals, (e.g., a set of training visuals), and generating results (e.g., training Q-LIP model, reconstructed visuals, statuses) from the execution of the methods and processes described herein, such as updating training models for Q-LIP or constructing new visuals. Q-LIP controller 800 includes a communications interface 810, a memory 820, and a processor 830.

Communications interface 810 can be configured to transmit and receive data. For example, communications interface 810 can receive the input parameters, the input text, and the visuals. Communications interface 810 can transmit the output or interim outputs. In some aspects, communications interface 810 can transmit a status, such as a success or failure indicator of Q-LIP controller 800 regarding receiving the various inputs, transmitting the generated outputs, or producing the results.

In some aspects, processor 830 can perform the operations as described by Q-LIP processor 720. Communications interface 810 can communicate via communication systems used in the industry. For example, wireless or wired protocols can be used. Communications interface 810 can perform the operations as described for data transceiver 710 and result transceiver 730 of FIG. 7.

Memory 820 can be configured to store a series of operating instructions that direct the operation of processor 830 when initiated, including supporting code representing the algorithm for performing the stage 1 decoding, the stage 2 decoding, the transformation, or the autoregressive generation. Memory 820 can be a non-transitory computer-readable medium. Multiple types of memory can be used for the data storage systems, and memory 820 can be distributed.

Processor 830 can be one or more processors. Processor 830 can be a combination of processor types, such as a CPU, a GPU, a single instruction multiple data (SIMD) processor, or other processor types. Processor 830 can be configured to produce the output, one or more interim outputs, and statuses utilizing the received inputs. Processor 830 can determine the output using parallel processing (e.g., using a parallel processing system). Processor 830 can be an integrated circuit. In some aspects, processor 830, communications interface 810, memory 820, or various combinations thereof, can be an integrated circuit. Processor 830 can be configured to direct the operation of Q-LIP controller 800. Processor 830 includes the logic to communicate with communications interface 810 and memory 820, and perform the functions described herein. Processor 830 can be capable of performing or directing the operations as described by Q-LIP processor 720 of FIG. 7.

For example, in some aspects, Q-LIP system 700 or Q-LIP controller 800 can perform the operations as described for the Q-LIP processes. In some aspects, Q-LIP system 700 or Q-LIP controller 800 can be part of another system that receives the input parameters, input text, and visuals. For example, in some aspects, Q-LIP system 700 or Q-LIP controller 800 can be part of a machine learning system, an AI generative tool, or can be in a data center, a cloud system, an edge system, a corporate system, or other types of systems or locations. In some aspects, Q-LIP system 700 or Q-LIP controller 800 can be part of a machine learning system, where Q-LIP processor 720 can be part of the machine learning processes. In some aspects, Q-LIP system 700 or Q-LIP controller 800 can implement a non-transitory computer program product having a series of operating instructions stored on a non-transitory computer-readable medium that directs a data processing apparatus when executed thereby to perform operations, the operations comprising the steps described herein for this disclosure, such as method 600 of FIG. 6. In some aspects, Q-LIP system 700 or Q-LIP controller 800 can implement a non-transitory computer-readable medium having a series of operating instructions that direct a data processing apparatus when executed thereby to perform the operations.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks. The processors or computers can be part of GPU racks located in a data center. The GPU racks can be high-density (HD) GPU racks that include high-performance GPU compute nodes and storage nodes. The high performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that may need a massive compute compute-intensive server infrastructure. For example, the GPU data centers employing HD GPU racks can provide the storage and networking needed to support large-scale neural network (NN) training, such as for the NNs disclosed herein used for neural motion planners. The NNs can be one or more deep neural networks (DNNs).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as those noted above are capable of delivering the performance for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Additional material is also submitted herewith.

Various aspects of the disclosure can be claimed, including the apparatuses, systems, and methods as noted in the Summary. Each of the noted aspects can have one or more of the additional features of the below dependent claims in combination.

What is claimed is:

1. A quantized language-image pretraining (Q-LIP) system to train a Q-LIP model using two stages, comprising:
a text encoder configured to generate encoded text from input text corresponding to a set of training visuals that are sourced from one or more of images or frames of videos;
a visual encoder configured to generate encoded images from the set of training visuals;
a quantizer configured to fine-tune the encoded images using the encoded text to generate quantized encoded images; and
a visual decoder configured to construct new visuals from the quantized encoded images,
wherein in a first stage the visual encoder generates the encoded images and the text encoder generates the encoded text, and
the first stage utilizes a first stage batch size, and
wherein, in a second stage, the text encoder is not used, the visual encoder does not make further changes to the encoded images, the quantizer fine-tunes the encoded images, the visual decoder fine-tunes the encoded images after the quantizer, and a second stage batch sized is used with the quantizer that is smaller than the first stage batch size.

2. The Q-LIP system as recited in claim 1, further comprising:
a transformer configured to transform the encoded images to a set of discrete tokens and insert tokens as padding within the set of discrete tokens; and
an autoregressive modeler configured to construct a new visual using the set of discrete tokens.

3. The Q-LIP system as recited in claim 1, wherein the quantizer is a binary spherical quantization auto-encoder.

4. The Q-LIP system as recited in claim 1, wherein the visual encoder utilizes a mean squared error loss between the set of training visuals and the encoded images.

5. The Q-LIP system as recited in claim 1, wherein the quantizer fine-tunes the encoded images using a weighted sum of a mean squared error loss, a perceptual loss, and a generative adversarial network loss.

6. The Q-LIP system as recited in claim 1, wherein the text encoder and the visual encoder utilize a contrastive loss objective to train a visual representation from natural language.

7. The Q-LIP system as recited in claim 1, wherein the first stage uses an optimization loss objective of a weighted sum of a reconstruction loss, a quantization loss, and a contrastive loss.

8. The Q-LIP system as recited in claim 1, wherein the second stage uses a fine-tuning objective of [symbol] [αᵣ′ [symbol] +α_{q}′ [symbol] +αₚ′ [symbol] +α′ [symbol] ].

9. The Q-LIP system as recited in claim 1, wherein the visual encoder is initialized using a masked image modeling pre-training and the text encoder is initialized using a contrastive language image pre-training objective.

10. The Q-LIP system as recited in claim 1, wherein a reconstruction objective and an alignment objective are balanced by first training the Q-LIP model with a first loss weight of one of a reconstruction loss or an alignment loss, and then training the Q-LIP model using a second loss weight that is inversely proportional to the first loss weight.

11. The Q-LIP system as recited in claim 1, wherein the quantizer utilizes a multi-layer perceptron model, and an auxiliary term of ∥sg(\hat{Z})−Z∥₂ is added by the quantizer.

12. The Q-LIP system as recited in claim 1, wherein a query-key normalization is applied in a first attention layer of the input text and a second attention layer of the set of training visuals.

13. The Q-LIP system as recited in claim 1, wherein the text encoder and the visual encoder each apply a logit shift correction algorithm.

14. The Q-lip system as recited in claim 1, wherein the quantizer utilizes a calm-down schedule for a proportion of text data decaying with respect to subsequent training steps.

15. A system, comprising:
a receiver, configured to receive input parameters, input text, and a set of training visuals, wherein the input text corresponds to the set of training visuals; and
one or more processors configured to generate encoded text from the input text, generate encoded images from the set of training visuals, quantize the encoded text and the encoded images to generate a set of discrete tokens, fine-tune the set of discrete tokens,
wherein the encoded text and the encoded images are generated in a first stage using a first batch size and a first loss objective, and
the set of discrete tokens are generated in a second stage using a second batch size and a second loss objective, where the first batch size is larger than the second batch size.

16. The system as recited in claim 15, further comprising:
a transformer configured to transform the set of discrete tokens to construct an output set of visuals using an autoregressive multimodal model.

17. The system as recited in claim 16, wherein the transformer is a second set of one or more processors.

18. The system as recited in claim 15, wherein the set of training visuals is one or more of images, videos, or frames from a video.

19. The system as recited in claim 15, wherein the one or more processors is a machine learning system.

20. The system as recited in claim 15, wherein the one or more processors is one or more of a central processor unit (CPU) or a graphics processor unit (GPU).

21. A method, comprising:
receiving input parameters, input text, and a set of training visuals, wherein the input text corresponds to the set of training visuals;
encoding the input text to generate encoded text;
encoding the set of training visuals to generate encoded images;
generating a set of discrete tokens using a quantizer, the encoded text, and the encoded images; and
fine-tuning the set of discrete tokens,
wherein the encoded text and the encoded images are generated in a first stage using a first batch size and a first loss objective, and
the set of discrete tokens are generated in a second stage using a second batch size and a second loss objective,
where the first batch size is larger than the second batch size.

22. The method as recited in claim 21, further comprising:
applying an autoregressive multimodal model to the discrete tokens to generate a set of result tokens, wherein the autoregressive multimodal model estimates new objects and new positions of objects from the set of training visuals.

23. The method as recited in claim 22, further comprising:
decoding the set of result tokens using a video decoder to construct a new set of visuals.

24. The method as recited in claim 21, wherein the first loss objective is an alignment loss objective and a mean square error loss objective, and the second loss objective is a weighted sum of the mean square loss objective, a perceptual loss objective, and a generative adversarial network loss objective.

25. A non-transitory computer program product having a series of operating instructions stored on a non-transitory computer-readable medium that directs a data processing apparatus, when executed thereby to perform operations, the operations comprising:
receiving input parameters, input text, and a set of training visuals, wherein the input text corresponds to the set of training visuals;
encoding the input text to generate encoded text;
encoding the set of training visuals to generate encoded images;
generating a set of discrete tokens using a quantizer, the encoded text, and the encoded images;
fine-tuning the set of discrete tokens, wherein the encoded text and the encoded images are generated in a first stage using a first batch size and a first loss objective, and the set of discrete tokens is generated in a second stage using a second batch size and a second loss objective, where the first batch size is larger than the second batch size; and
applying an autoregressive model to generate new visuals using the set of discrete tokens.

26. The non-transitory computer program product as recited in claim 25, wherein the operations are executed using a machine learning system or a deep neural network.
